(19) United States
(12) Patent Application Publication
(10) Pub. No.: US 2023/0288273 A1
(43) Pub. Date: Sep. 14, 2023

(54) TORQUE DETERMINATION SYSTEM

(71) Applicant: NTN-SNR ROULEMENTS, Annecy (FR)

(72) Inventors: Cécile Flammier, Annecy-Le-Vieux (FR); Christophe Duret, Bluffy (FR)

(21) Appl. No.: 18/112,479

(22) Filed: Feb. 21, 2023

(30) Foreign Application Priority Data
Feb. 25, 2022 (FR) 2201676

(51) Int. Cl. G01L 3/10

(52) U.S. Cl. CPC G01L 3/101

(57) ABSTRACT

A system for determining a torque includes a test body having two bushings, an encoder having two multipolar tracks with a polar width Lpᵢ and Lpₑ respectively, a sensor having a first (20) - respectively a second (21) - pattern of sensitive elements disposed at a reading distance eᵢ - respectively eₑ - from the internal track (7) - respectively from the external track (8), and a device for comparing the signals delivered by the sensor to determine an angle between the bushings which depends on the applied torque, the trackshaving an identical number of pairs of poles which are radially aligned, the reading distances eₑ and eᵢ between the patterns of sensitive elements and the tracks being such that: :

$$\frac{{e}_{e}}{L {p}_{e}} = \frac{{e}_{i}}{L {p}_{i}} .$$

eₑ

### BACKGROUND

The invention relates to a system for determining a torque and a method for making an encoder for such a system.

In particular, the invention applies to the determination of a torque applied between two members rotating about a geometric axis of rotation, in particular two members integrated in a transmission of a motor torque to a vehicle, for example between the electric motor and the mechanical transmission of an electrically power assisted bicycle.

For this purpose, it is known to use a test body having an internal bushing secured in rotation with means for mounting said test body on one member, and an external bushing extending around the internal bushing while having means for mounting said test body on the other member, said bushings being connected by a deformable structure which is arranged to transmit the torque between the members while enabling an angular displacement between said bushings according to the torque applied between the members.

Such a test body can be instrumented with an encoder by equipping each of the bushings with a ring carrying respectively an internal and an external magnetic track which is able to emit a periodic signal representative of the rotational movement of the corresponding bushing. In particular, each of the tracks has a succession of pairs of North and South poles to form a multipolar magnetic track delivering a pseudo-sine shaped magnetic signal.

The determination system then comprises a sensor having a first - respectively a second - pattern of sensitive elements disposed at a reading distance from the internal track - respectively from the external track - to form a signal representative of the angular position of the corresponding ring.

The document FR-2 821 931 describes the use of a device for comparing such signals which is able to determine an angle of relative displacement of the bushings, and therefore the applied torque as it induces said angle by torsion of the bushings.

The limitation of this solution lies in the accuracy of the determination of the torque, in particular with regards to very rigid test bodies to avoid feeling the torsion angle in the transmission.

In particular, the multipolar magnetic tracks do not deliver a perfectly sine shaped signal, in particular depending on the reading distance between the patterns of sensitive elements and said track, which could cause an error when comparing the position signals to determine the angle which depends on the applied torque.

### SUMMARY OF THE DISCLOSURE

The invention aims to solve the problems of the prior art in particular by providing a system for determining an applied torque wherein the sinusoidality defects of the delivered magnetic signals do not affect the accuracy of the determination.

To this end, according to a first aspect, the invention provides a system for determining a torque applied between two members rotating about a geometric axis of rotation, said system comprising:
a test body having an internal bushing secured in rotation with means for mounting said test body on one member, and an external bushing extending around the internal bushing while having means for mounting said test body on the other member, said bushings being connected by a deformable structure which is arranged to transmit the torque between the members while enabling an angular displacement between said bushings according to the torque applied between the members;
an encoder made by equipping each of said bushings with a ring respectively carrying an internal and external magnetic track which is able to emit a periodic signal representative of the rotational movement of the corresponding bushing, each of said tracks having a succession of pairs of North and South poles respectively with a polar width Lpᵢ and Lpₑ to form a multipolar magnetic track;
a sensor comprising a first respectively a second pattern of sensitive elements disposed at a reading distance eᵢ - respectively eₑ - from the internal track - respectively from the external track - to form a signal representative of the angular position of the corresponding ring;
a device for comparing the signals delivered by the sensor, said device being able to determine an angle between the bushings which depends on the applied torque;
the tracks have an identical number of pairs of poles which are radially aligned, the reading distances eₑ and eᵢ between the patterns of sensitive elements and the tracks being such that:

$$\frac{{e}_{e}}{L {p}_{e}} = \frac{{e}_{i}}{L {p}_{i}}$$

According to a second aspect, the invention provides a method for making an encoder for a determination system according to the first aspect, providing for:
fastening the rings on the bushings of a test body having an internal bushing secured in rotation with means for mounting said test body on one member, and an external bushing extending around the internal bushing while having means for mounting said test body on the other member, said bushings being connected by a deformable structure which is arranged to transmit the torque between the members while enabling an angular displacement between said bushings according to the torque applied between the members; then
magnetising each of the magnetic tracks concentrically so that they have a common axis of revolution.

### BRIEF DESCRIPTION OF THE SEVERAL VIEWS OF THE DRAWING

Other objects and advantages of the invention will appear in the following description, made with reference to the appended figures, wherein:

FIG. 1 is a front representation of a test body of a determination system according to the invention;

FIG. 2 is a cross-sectional view of the test body of FIG. 1 showing the arrangement of the sensor according to an embodiment of the invention,

FIG. 2a being an enlarged view of FIG. 2;

FIG. 2b is a view similar to FIG. 2a showing another arrangement of the sensor with respect to a test body according to the invention.

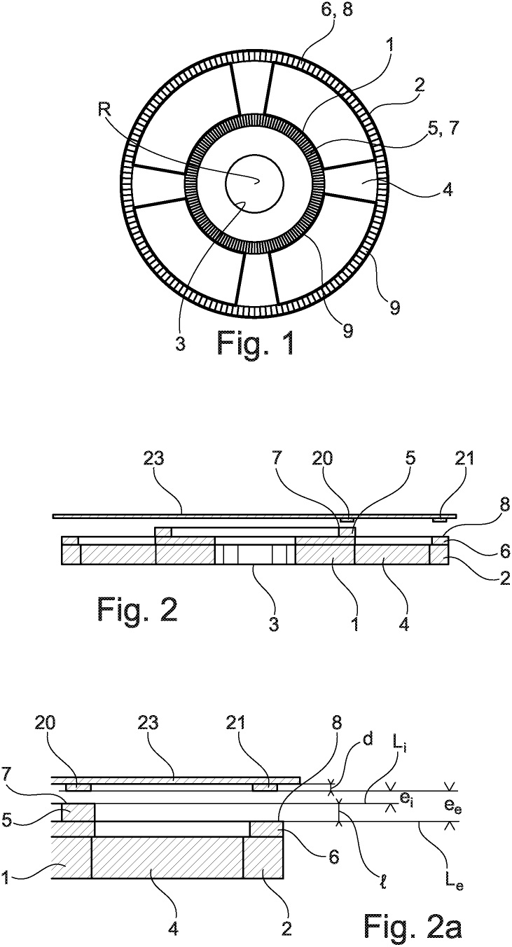

### DETAILED DESCRIPTION OF THE PREFERRED EMBODIMENTS

Referring to these figures, a system for determining a torque applied between two members rotating about a geometric axis of rotation R is described hereinbelow.

In particular, the system enables the determination of a torque applied between two members integrated in a transmission of a motor torque to a vehicle, for example between the electric motor and the mechanical transmission of an electrically power assisted bicycle.

The system comprises a test body having an internal bushing 1 secured in rotation with means for mounting said test body on one member, and an external bushing 2 extending around the internal bushing 1 while having means for mounting said test body on the other member.

The bushings 1, 2 are connected by a deformable structure which is arranged so as to transmit the torque between the members while enabling an angular displacement between said rings according to the torque applied between said members.

In the represented embodiment, the rings 1, 2 are concentric around a mounting sleeve 3 on the geometric axis of rotation R, for example a shaft for transmitting the torque to another shaft on which the external bushing 2 is mounted, the deformable structure comprising at least one radial arm 4 - four arms angularly distributed in an even manner in the figures - which connects the bushings 1, 2.

Thus, the torque transmitted between the shafts induces a torsion of the bushings 1, 2 and therefore a relative angular movement of said bushings according to a torsion angle which depends on said torque, the system determining said torque on the basis of the measurement of said torsion angle.

For this purpose, an encoder is made with the test body by equipping each of the bushings 1, 2 respectively with an internal 5 and external 6 ring respectively carrying an internal 7 and external 8 magnetic track which is able to emit a periodic signal representative of the movement of said rotating ring, the system comprising a sensor for measuring the angular position of each of said rings.

In particular, a succession of pairs of North and South poles 9 is magnetised respectively on one ring 5, 6 to form a multipolar magnetic track 7, 8 able to emit a pseudo-sine shaped magnetic signal. The internal 7 and external 8 tracks have poles 9 which have a polar width respectively Lpᵢ and Lpₑ which are arranged so that said tracks have an identical number of pairs of poles 9 which are radially aligned so as to deliver in-phase magnetic signals.

For example, if the external ring 6 has a diameter twice that of the internal ring 5, the polar width Lpₑ of the poles 9 of said external ring will be twice the width Lpᵢ.

The rings 5, 6 may comprise an annular matrix, for example made based on a plastic or elastomeric material, in which magnetic particles are dispersed, in particular ferrite or rare-earth particles such as NdFeB, said particles being magnetised so as to form the magnetic tracks 7, 8.

The sensor comprises a first 20 - respectively a second 21 - pattern of sensitive elements disposed at a reading distance eᵢ - respectively eₑ - from the internal track 7 - respectively from the external track 8 - to form a signal representative of the angular position of the corresponding ring 5, 6.

In particular, each pattern 20, 21 may comprise at least two sensitive elements, in particular a plurality of aligned sensitive elements as described in the documents FR-2 792 403, EP-2 602 593 and EP-2 602 594.

The sensitive elements may be based on a magneto-resistive material whose resistance varies according to the magnetic signal of the track 7, 8 to be detected, for example of the AMR, TMR or GMR type, or a Hall effect probe.

According to one embodiment, the angular position can be determined incrementally by means of the signal emitted by a magnetic track 7, 8. According to another embodiment, the angular position can be determined in an absolute manner, i.e. with respect to a reference position, by providing a secondary magnetic track or a specific coding on the ring 5, 6.

The system further comprises a device for comparing the signals delivered by the sensor, said device being able to determine an angle between the bushings 1, 2 which depends on the applied torque. Referring to the figures, the sensor comprises a board 23 over which the patterns 20, 21 of sensitive elements are embedded in an electronic circuit.

According to one embodiment, the sensors deliver incremental square signals in quadrature phase, the comparison device comprising counting means indicating the angular position of each of the rings 5, 6 and subtraction means allowing calculating the difference between said angular positions.

In particular, the sensor may comprise means for applying an interpolation factor fᵢ and fₑ to the signal delivered respectively by the first and second pattern of sensitive elements, the counting means measuring a number of fronts nᵢ and nₑ in each of said interpolated signals, the subtraction means performing for example the operation fₑ.nᵢ - nₑ.fᵢ to calculate the difference between the angular positions of the rings 5, 6.

When the interpolation factors are identical (fᵢ = fₑ), the calculation may be carried out by simple subtraction of the fronts ni and nₑ.

The reading distances eₑ and ei between the patterns 20, 21 of sensitive elements and the tracks 7, 8 are such that:

$$\frac{{e}_{e}}{L {p}_{e}} = \frac{{e}_{i}}{L {p}_{i}}$$

so as to compensate for the sinusoidality errors of the magnetic signals read by said patterns.

Moreover, to reduce the error due to the poor sinusoidality of the magnetic field, the reading distances eₑ and eᵢ may be respectively equal to Lpₑ/2 and Lpᵢ/2 +/-10%. On either side of this optimum position, the shape of the magnetic field as a function of the reading distance deteriorates. At short reading distance, the shape of the signal becomes more “square”, at large reading distance, it becomes more “triangular”.

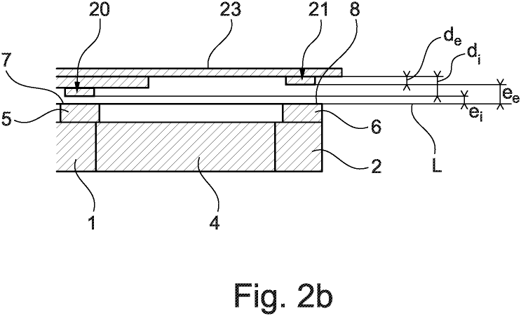

Referring to FIG. 2b, the relationship

$$\frac{{e}_{e}}{L {p}_{e}} = \frac{{e}_{i}}{L {p}_{i}}$$

is met by providing for each of the patterns 20, 21 to project axially from the board 23 over a distance dₑ for the external pattern 21 and di for the internal pattern 20, the distances dₑ and dᵢ being different and the rings 5, 6 being fastened on the bushings 1, 2 so that their tracks 7, 8 are disposed in a plane L.

This embodiment can be implemented by setting the height of the sensors or by making a printed circuit board including several levels (FIG. 2b). Moreover, if it is quite thin and flexible, a deformation of a printed circuit board could also allow meeting the relationship

$$\frac{{e}_{e}}{L {p}_{e}} = \frac{{e}_{i}}{L {p}_{i}} .$$

Referring to FIG. 2a, the rings 5, 6 are fastened on the bushings 1, 2 so that their tracks 7, 8 are respectively disposed in a plane Lᵢ and Lₑ which are spaced apart axially by a distance I to meet the relationship

$$\frac{{e}_{e}}{L {p}_{e}} = \frac{{e}_{i}}{L {p}_{i}} ,$$

the patterns 20, 21 being embedded on the board 23 projecting over a same distance d.

According to one embodiment, the relationship

$$\frac{{e}_{e}}{L {p}_{e}} = \frac{{e}_{i}}{L {p}_{i}}$$

can be met by combining different distances dₑ and dᵢ with a non-zero distance I.

The above-described encoder may be made by fastening at first the rings 5, 6 on the bushings 1, 2, then magnetising each of the magnetic tracks 7, 8 concentrically so that they have a common axis of revolution.

Advantageously, the method provides for fastening the rings 5, 6 concentrically on the bushings 1, 2 so that they have a common axis of revolution with the geometric axis of rotation R.

Prior fastening enables the rings 5, 6 to have the same mechanical eccentricity which is induced by a possible distance between their centre and the geometric axis of rotation R, and the subsequent magnetisation of the tracks allows obtaining a same magnetic eccentricity between their common axis of revolution and the geometric axis of rotation R.

Thus, the eccentricities being the same, their possible defects do not affect the accuracy of the determination of a torque by comparison of the angular position of each of the rings 5, 6, to the extent that the position error will then be the same and can therefore be eliminated by subtraction.

According to one embodiment, the tracks 7, 8 are magnetised by means of a tool which has two crowns for magnetising respectively one ring 5, 6 fastened on the body, the crowns may advantageously have a geometry similar to the geometry of one ring 5, 6 respectively.

This embodiment allows magnetising the tracks 7, 8 simultaneously while complying with their concentricity in a simple way to the extent that it is imposed by the geometry of the magnetisation crowns, as well as the same number of pairs of poles 9 radially aligned on the tracks 7, 8.

What is claimed is:

1. A system for determining a torque applied between two members rotating about a geometric axis of rotation (R), said system comprising:
a test body having an internal bushing secured in rotation with means for mounting said test body on one member, and an external bushing extending around the internal bushing while having means for mounting said test body on the other member, said bushings being connected by a deformable structure which is arranged to transmit the torque between the members while enabling an angular displacement between said bushings according to the torque applied between the members,
an encoder made by equipping each of said bushings with a ring respectively carrying an internal and external magnetic track which is able to emit a periodic signal representative of the rotational movement of the corresponding bushing, each of said tracks having a succession of pairs of North and South poles respectively with a polar width Lpᵢ and Lpₑ to form a multipolar magnetic track;
a sensor comprising a first (20) respectively a second (21) - pattern of sensitive elements disposed at a reading distance eᵢ - respectively eₑ - from the internal track (7) - respectively from the external track (8) - to form a signal representative of the angular position of the corresponding ring;
a device for comparing the signals delivered by the sensor, said device being able to determine an angle between the bushings which depends on the applied torque,
the tracks having an identical number of pairs of poles which are radially aligned, the reading distances eₑ and eᵢ between the patterns of sensitive elements and the tracks being such that:
$$\frac{{e}_{e}}{L {p}_{e}} = \frac{{e}_{i}}{L {p}_{i}} .$$
.

2. The determination system according to claim 1, the sensors delivering incremental square signals in quadrature phase, the comparison device comprising counting means indicating the angular position of each of the rings and subtraction means allowing calculating the difference between said angular positions.

3. The determination system according to claim 2, the sensor comprising means for applying an interpolation factor fᵢ and fₑ to the signal delivered respectively by the first and second pattern of sensitive elements, the counting means measuring a number of fronts nᵢ and nₑ in each of said interpolated signals, the subtraction means performing the operation f_{e▪}nᵢ - n_{e▪}fᵢ to calculate the difference between the angular positions of the rings.

4. The determination system according to claim 1, the reading distances eₑ and eᵢ being respectively equal to Lpₑ/2 and Lpᵢ/2 +/-10%.

5. The determination system according to claim 1, the sensor comprising a board over which the patterns of sensitive elements are embedded in an electronic circuit, each of said patterns projecting radially from said board over a distance dᵢ for the first pattern and dₑ for the second pattern.

6. The determination system according to claim 1, the rings being fastened on the bushings so that their tracks are respectively disposed in a plane Lᵢ and Lₑ which are spaced apart radially by a distance I.

7. The determination system according to claim 1, the deformable structure comprising at least one radial arm which connects the bushings.

8. A method for making an encoder for a system for determining a torque applied between two members rotating about a geometric axis of rotation (R) according to claim 1, comprising:
fastening the rings on the bushings of a test body having an internal bushing secured in rotation with means for mounting said test body on one member, and an external bushing extending around the internal bushing while having means for mounting said test body on the other member, said bushings being connected by a deformable structure which is arranged to transmit the torque between the members while enabling an angular displacement between said bushings according to the torque applied between the members; then
magnetizing each of the magnetic tracks concentrically so that they have a common axis of revolution.

9. The method for making an encoder according to claim 8, the tracks being magnetized simultaneously.
